(19) United States
(12) Patent Application Publication
(10) Pub. No.: US 2012/0207098 A1
(43) Pub. Date: Aug. 16, 2012

(54) SYSTEMS AND METHODS FOR CONTROLLING APPLICATION UPDATES ACROSS A WIRELESS INTERFACE

(75) Inventors: James W. Cooley, Seattle, WA (US); Neal E. Tucker, Seattle, WA (US)

(73) Assignee: ZenZui, Inc., Seattle, WA (US)

(21) Appl. No.: 11/690,582

(22) Filed: Mar. 23, 2007

(51) Int. Cl. H04Q 7/00

(52) U.S. Cl. 370/329

(57) ABSTRACT

The present invention is directed to a system and method for managing connections between a mobile device and a network server over a single connection in a bandwidth-efficient manner. In one embodiment, a single persistent wireless interface connection is maintained in a manner that allows for multiplexing several services over that connection in a dynamic service priority manner. Each type of data that is to be communicated across the air interface has a priority associated therewith. By managing the data transfer in accordance with its priority, the bandwidth of the total data transfer across the interface is managed so as to conserve battery life and minimize the bandwidth required at any point in time. From time to time, the priority of any given type of data can be adjusted dynamically depending upon several factors. Thus, it is possible to delay certain data transfers in favor of other data transfers, thereby conserving bandwidth and battery life.

### CROSS-REFERENCE TO RELATED APPLICATIONS

This patent application is related to concurrently filed, co-pending, and commonly-assigned: U.S. patent application Ser. No. ______, Attorney Docket No. 72514/P002US/10703618, entitled “SYSTEMS AND METHODS FOR COORDINATING THE UPDATING OF APPLICATIONS ON A COMPUTING DEVICE”; U.S. patent application Ser. No. ______, Attorney Docket No. 72514/P003US/10703619, entitled “SYSTEMS AND METHODS FOR CONTROLLING GROUP MESSAGING”; the disclosures of which are incorporated herein by reference.

### TECHNICAL FIELD

This disclosure relates to wireless bandwidth management and more particularly to systems and methods for adaptive bandwidth management in wireless communication systems and even more particularly to systems and methods for efficiently updating applications that reside on a wireless device.

### BACKGROUND OF THE INVENTION

In many situations, such as, for example, when it is required to update or change an application that is running on a mobile device, the updated or new information typically is located on the network side of the wireless interface. Thus that information must then be transmitted across the wireless interface to the device, such as a cell phone, where the application resides.

Several problems exist when attempting to manage such application updates. These problems stem from several factors, one of which is that a typical mobile wireless network has high latency and relatively low bandwidth. In addition, the wireless interface is subject to drop-outs and thus often there is difficulty maintaining a channel. Also, the use of the wireless interface causes battery drain on the mobile device and thus there is always concern as to when transmission occurs and for how long.

An additional set of problems exist when the data exchange is via the HTTP protocol which is a client initiated protocol. In this instance, the client being the mobile device. Thus, the situation exists that the update data resides in the network while the connection must be initiated from the mobile device, all while conserving bandwidth and battery life of the mobile device.

### BRIEF SUMMARY OF THE INVENTION

The present invention is directed to a system and method for managing connections between a mobile device and a network server over a single connection in a bandwidth-efficient manner. In one embodiment, a single persistent wireless interface connection is maintained in a manner that allows for multiplexing several services over that connection in a dynamic service priority manner. Each type of data that is to be communicated across the air interface has a priority associated therewith. By managing the data transfer in accordance with its priority, the bandwidth of the total data transfer across the interface is managed so as to conserve battery life and minimize the bandwidth required at any point in time. From time to time, the priority of any given type of data can be adjusted dynamically depending upon several factors. Thus, it is possible to delay certain data transfers in favor of other data transfers, thereby conserving bandwidth and battery life.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows one embodiment of a mobile device utilizing the concepts of the invention; and

FIGS. 2 and 3 show embodiments of methods for controlling the operation of the application update function of the device shown in FIG. 1.

### DETAILED DESCRIPTION OF THE INVENTION

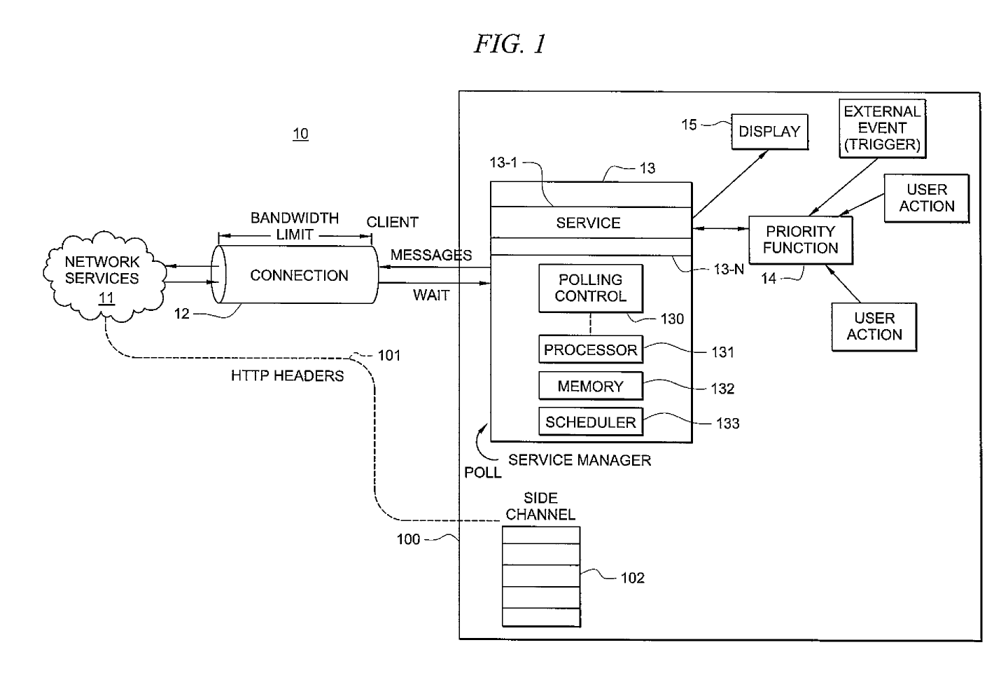

FIG. 1 shows one embodiment 10 of a mobile device 100 (only a portion of which is illustrated) utilizing the concepts of the invention. Connection 12 exists between device 100 and network server 11. Connection 12 has a bandwidth limitation, either imposed by the physical network or imposed by the user such that the user is only willing to pay for a certain amount of data transmission (often measured in bytes per unit time). Sometimes the cost per byte is less expensive at certain times (such as at night) so the user prefers to use “night” bytes instead of “day” bytes when possible.

Device 10 contains service manager 13 which in turn controls various services (or data types) 13-1 to 13-N. Each of the services 13-1 to 13-N has associated therewith a priority function 14. The purpose of each service 13-1 through 13-N is to perform a particular function (application) that ultimately results in data displayed to the user via display 15. Each service 13-1 through 13-N requires some time (bandwidth) on the wireless interface and service manager 13 balancing each bandwidth request against all other service bandwidth requests against a number of factors. The priority of each service is incorporated into the priority function for each service. Since the overall connection has a bandwidth limit, the availability of the connection to any particular service is balanced across all services according to an individual priority function associated with each service. Since the priority function for a given service can change from time to time, the use of the connection is dynamically balanced and thus adapts to user load patterns in accordance with each user's needs and desires. This adaptation can use a variety of functions, such as, for example, Baysian or support vector machine and can support adaptive or designed balancing or combinations thereof.

For example, assume a user desires to use only one megabyte per day. That megabyte is rationed out in some order during the day according to a plan for that user. The plan can, for example, be based on statistics, for example, B-spline or linear, for that user, or on anyone of many other techniques, such as, for example, probability of usage of target application or data, neural network, location-based function, GPS. The air transport time can be rationed at so many megabytes per hour, if desired. The service manager then will only allow the connection to be used up to the threshold limit. To accomplish this, the service manager periodically pulls through the list of services that require bandwidth and processes the highest priority service first until it reaches the bandwidth limit set for the connection. The service manager then waits until the next pulling interval and repeats the process. The priority functions themselves are constantly changing their priority levels and thus at each polling opportunity the highest priority functions are served first.

For example, assume that a user desires to have a weather application, a news application and a sports application. The weather application may have a high priority assigned to it during the hours of 6 AM to say 9 AM. Thus, during these hours the weather information is updated every, say ten minutes. Likewise, the news application has a high priority in the morning but then switches so that only “breaking” news stories are reported during the day. The sports application has a priority such that scores are reported only at 6 AM and then again only at 10 PM, except that when a favorite team (or teams) are actually playing then the priority changes to every five minutes.

Another example would be when the user performs an action, such as pressing a key or changing the view on the display. This action then could immediately change the priority function of the associated application (service). This then would allow the service manager to control updates on a more immediate basis.

Many wireless devices, such as for example, cellular telephones, allow communications over several channels, One such channel is a main two-way real time channel which is typically used for concurrent bidirectional speech communications. Another channel, for example, is a data channel that could be used separately from the speech channel. While the concepts discussed herein can be used on either channel, it is expected that the service manager will use the data channel. During the time the service manager is managing the connection, there can be a side channel of HTTP headers, such as headers 101. These side channel headers piggyback on other messages. For instance, if service A is communicating with server 11, service B can also communicate with the server at the same time on the same message using a side channel message such as message 102.

The purpose of the side channel is to process certain class of service requests that are small but frequent or potentially frequent, but where it is not necessary to establish an explicit transaction on the network. Thus, when one service makes a request and gets a response, several other services can have their small but important requests multiplexed on the established requests so that they effectively share that time slice. An example would be for an application to check for the presence of an update such that if an update exists (i.e. there is a “flag” set). Thus, the flag message can serve to allow time to be scheduled for the actual updating of the application.

Note that while FIG. 1 shows a single manager and only one connection, in actuality there can be many connections, each with a service manager. In one embodiment, each connection is to a separate URL and thus there is a one to one relationship between the service manager and a connection. In this embodiment, all services which connect to the same host (URL) are associated with the same single service manager and with the same connection. In this manner when processing service requests, the system can connect to the same host and port and thus the connection can be opened only once for all the applications that communicate with the same server. This reduces the overhead of the communication by leaving the socket open for multiple services. In turn, this reduces battery usage because the device radio is used less.

Another example of dynamic function changing is when messages are being sent back and forth to another mobile device. The user then wants the message sending and receiving service to have a high priority during this exchange but then also wants that priority to taper off over time as the conversation dies so that the device does not use up a lot of network bandwidth checking for messages. The priority function could be anything that is reset by user actions. Examples of priority changes are: periodic, constant, decreasing priority, increasing priority.

Another example would be using statistics about times when network access has been accomplished or when things are available. This would work well for applications that change over time, such as a traffic map. The priority function would track and the changes in traffic patterns during, for example, rush hours and could therefore dynamically increase and decrease it's priority assigned to updating the information from the server.

The priority could be tailored to usage. For instance, if the user always begins his/her day by looking at the traffic information, then checking the news and then looking at the weather icon on the display. These items can be clustered to update as a group. Using this arrangement, the system might be a little late on traffic, but will be ahead on the other services in that group. For a flight icon (tile), for instance, one of things that affects the priority might be the proximity in time to the flight. As the flight time approaches, the priority can go higher for updating departure and gate information. The system might update once a day when the flight is a couple of days out, and then start updating at, say, 15 minute intervals, when it is within a few hours of flight time.

Also, the system might have a flight tile that contains several airlines on it. When the tile is selected the system could determine which airline has the highest priority from the several possible airlines on the tile with the priority based on calendar information available to the system. Thus, if the user is booked on an American Airlines flight the user probably does not need an update of Continental flights at that point in time.

Thus, by having access to other information, the priority of the information into the phone can be managed consistent with reducing bandwidth and battery drain in order to give the user increased value from the device. Thus, when it is snowing outside, the phone could sound an alarm earlier than normal to alert the user to longer commute times based on the knowledge of the weather and the user's calendar of scheduled activities.

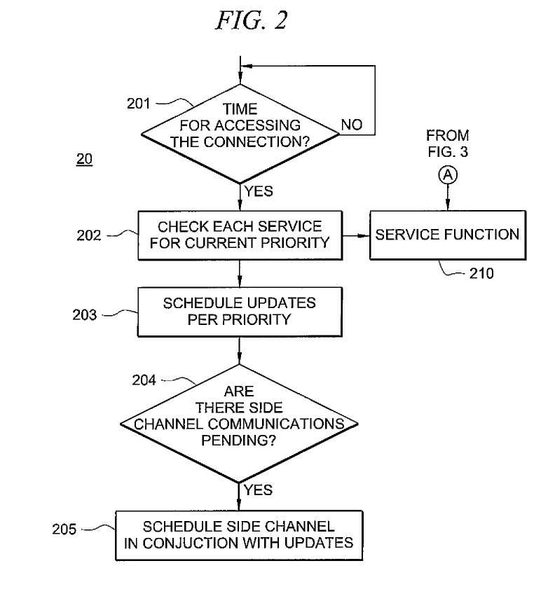

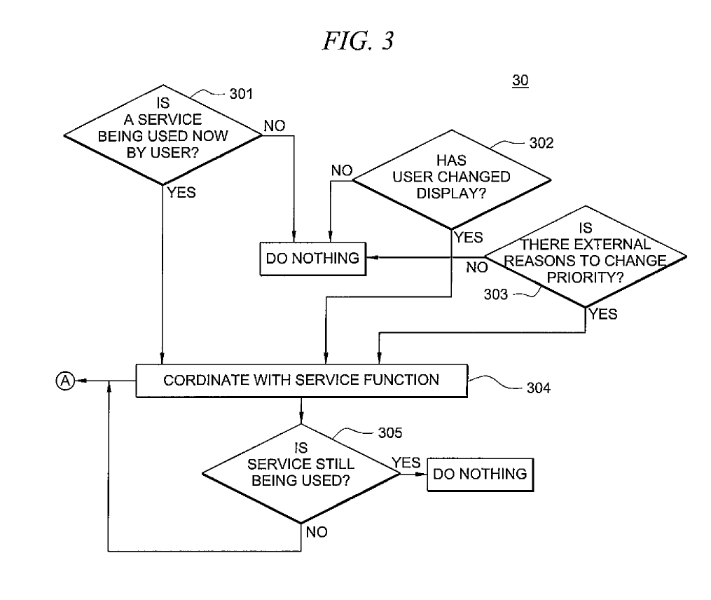

FIGS. 2 and 3 show embodiments of methods for controlling the operation of the application update function of the device shown in FIG. 1. In FIG. 2, embodiment 20 begins with process 201 determining if it is time for accessing a particular network server for those applications which reply on that server for updated information. This time is determined by a combination of calculations based on current battery level, time of day, current activity of the user with respect to the device, how long it has been since the last access to the server, how much data has already been transmitted in a given unit of time, etc. When it is time to make an access, then process 202 checks each service to determine relative priority of that application and then based on the relative priority and the available bandwidth for that connection, as determined by process 201, working in conjunction with process 210, one or more applications are updated by process 203.

Process 204 determines whether there are side channel communications that need to occur, and if so, process 205 schedules those communications.

Processes 301, 302 and 303 of embodiment 30, as shown in FIG. 3, are examples of processes that determine if a priority is to be changed at a particular time. Thus, process 301 determines if a service is being used by the user, process 302 determines if the user has changed the display (for example, by selecting a tile, or a particular service within a tile); and process 303 determines if there is some external reason to change priority. Such an external reason could be, for example, a breaking news story, a sports event going into overtime, weather conditions turning hazardous, etc.

Process 304 then coordinates this information with process 210, as shown in FIG. 2, so as to change the priority of the service. Process 305 determines when a user has stopped using a service. For example, instant messaging is finished and thus the priority for that service can return to its normal priority level. Note that the examples discussed above are only a few of the many factors that can change priority on a dynamic basis and in many situations multiple factors are used to determine relative priority and timing for a network server access, all coordinated to conserve bandwidth and battery life for the user. In one embodiment, the operations in the device are controlled by machine executable code running under control of, for example, processor 131.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of managing application updates on a mobile device; said method comprising:
associating a priority function with each said application;
dynamically adjusting said priority function on an application by application basis; and
retrieving application updated data over a wireless network, said application updated data retrieved based at least in part on a current priority function for each application.

2. The method of claim 1 wherein said retrieving is based at least in part on bandwidth limitations over said wireless network.

3. The method of claim 2 wherein said dynamically adjusting for a particular application is based on at least one function from the list of: known uses for said particular application; time of day; frequency of use of said particular application; bandwidth used for a period of time; battery usage, current device activity.

4. The method of claim 2 wherein said retrieving is from a server and wherein said server provides data for a plurality of applications; said method further comprising:
coordinating said retrieval of data for all applications on said mobile device through a single connection between said server and said mobile device.

5. The method of claim 4 wherein said coordinating is based upon a relative current priority function of each said application served by said server.

6. The method of claim 4 further comprising:
adding side channel messages to any said connection between said server and said mobile device.

7. The method of claim 6 wherein said side channel messages comprise messages that are short in duration as compared to said updated application data.

8. The method of claim 6 wherein said retrieving comprises:
pausing all data retrieval for a period of time based upon allocated bandwidth.

9. A mobile device having a plurality of user available applications contained thereon; said device comprising:
a message connection manager for controlling a wireless communication channel between said device and a particular network location; and
a service manager for coordinating updates to device applications from said particular network location, said updates managed from time to time based upon a then current relative priority among said applications.

10. The mobile device of claim 9 wherein all device applications that require updates from said particular network location communicate with said particular location over said controlled wireless communication channel.

11. The mobile device of claim 9 wherein said message manager is operable for pausing any data transfer over said communication channel for periods of time based, at least in part, on an allocation of bandwidth as a function of time.

12. The mobile device of claim 11 wherein said service manager is operable for dynamically changing a priority of any said application.

13. The mobile device of claim 12 wherein said dynamically changing priority for a particular application is based upon at least one of the following: known uses for said particular application; time of day; frequency of use of said particular application; bandwidth used for a period of time; estimated battery level; current device activity.

14. The mobile device of claim 10 further comprising:
at least one additional message connection manager for controlling a separate wireless communication channel between said device and other particular network locations, each said separate wireless communication channel handling updates for all applications that receive updates from said particular other network location.

15. Machine controllable code for use in a mobile wireless telephone, said code operable for:
controlling a communication channel between said telephone and a particular network location; and
managing updates from said particular network location to applications resident on said telephone, said updates managed from time to time based upon a then current relative priority among said applications.

16. The code of claim 15 further operable for
pausing any data transfer for periods of time based, at least in part, on an allocation of bandwidth as a function of time.

17. The code of claim 16 further operable for:
dynamically changing a priority of any said application.

18. The code of claim 17 wherein said dynamically changing priority for a particular application is based upon at least one of the following: known uses for said particular application; time of day; frequency of use of said particular application; bandwidth used for a period of time; battery usage; current usage of said telephone.

19. The code of claim 18 further operable for:
coordinating data transfer between said telephone and particular location over side channels of said communication channel.

20. The code of claim 19 wherein said last-mentioned data transfer is used for transferring flag signals between said particular network location and said telephone.
